(19) United States
(12) Patent Application Publication
(10) Pub. No.: US 2011/0041710 A1
(43) Pub. Date: Feb. 24, 2011

(54) EGG SPINNER

(76) Inventor: John Collins, Chandler, AZ (US)

Correspondence Address: KEITH L. JENKINS, Registered Patent Attorney, LLC, 44075 W. Neely Drive, Maricopa, AZ, 85138, US

(21) Appl. No.: 12/862,672

(22) Filed: Aug. 24, 2010

Related U.S. Application Data
(60) Provisional application No. 61/236,484, filed on Aug. 24, 2009.
(60) Provisional application No. 61/258,910, filed on Nov. 6, 2009.
(60) Provisional application No. 61/263,354, filed on Nov. 21, 2009.

(51) Int. Cl. A47J 43/14; A23J 1/09

(52) U.S. Cl. 99/498; 99/500

(57) ABSTRACT

A centrifugal egg separator that has a plurality of user-selectable discrete rotational speeds for performing a corresponding plurality of egg separation operations. Up to two speeds may correspond to centrifugal egg breaking: one for separating yolk and albumin from shell and chalazae and one for separating yolk, albumin, and chalazae from shell. Up to three speeds may correspond to separating components of broken eggs: one for separating out only albumin, one for separating out the yolk and albumin, and one for separating out the yolk, albumin, and chalazae. May be used with a customized food processor base. Various lid designs are included.

### CROSS-REFERENCES TO RELATED APPLICATIONS

This application claims the benefit of U.S. Provisional Application No. 61/236,484, filed Aug. 24, 2009, U.S. Provisional Application No. 61/258,910, filed Nov. 6, 2009, and U.S. Provisional Application No. 61/263,354 filed Nov. 21, 2009.

### FIELD OF THE INVENTION

This invention relates to a consumer-usable food-processing centrifuge specially adapted to separating poultry egg yolk, albumin, chalazae, and egg shell. The invention further relates to a centrifugal egg separator that has a plurality of user-selectable discrete rotational speeds for performing a corresponding plurality of egg separation operations.

### BACKGROUND

Spinning vegetables, especially salad vegetables, to remove moisture from the surface of the vegetables, especially after washing, is known in the art of food preparation. Likewise, spinning fried foods to remove grease from the fryer is known in the art of food preparation. However, vegetable spinners have centrifuge baskets with large slots to allow quick release of the water from the vegetables. Such slots are too large for dewatering small food solids. The slots conventionally used in grease removers conventionally have even larger openings. Salad spinners operate at fairly low speeds. Salad spinners avoid crushing the vegetables with centrifugal force. Grease removers operate at higher speeds, but must avoid breaking the fried crust on the fried food. Neither class would be suitable for spinning eggs, as pieces of the shell would escape through the basket openings, and the centrifugal force at such speeds would be insufficient to separate the albumin and yolk from the shell.

Centrifugal juicers operate at higher speeds, and conventionally have some mechanism for piercing the pulp, such as sharp inward protrusions on the centrifuge basket or blades intruding into the centrifuge chamber. Such cutting devices are problematic for egg spinning, as they tend to powder the egg shell, allowing egg shell powder to escape into the extracted albumin and yolk.

Eggs have an outer shell, albumin (egg white), yolk in a yolk sack, and a structural extension from the yolk sack called chalazae, sometimes called a “stringer”. Chalazae support the yolk to remain in the middle of the egg. Some egg consumers regard consuming chalazae as repulsive, and gourmet cooks find that it makes lumps in meringue and other egg dishes.

A large number of gravity-operated egg separators are commercially available for separating the yolk, with chalazae attached, from the albumin. Such devices are typically a cup or slide for retaining the yolk and the chalazae, wherein the cup or slide has openings that allow passage of the albumin, under the force of its own weight, to separate from the yolk and chalazae. Some such devices include an egg-breaking mechanism to open the shell and release the yolk, chalazae, and albumin into the cup or slide.

U.S. Pat. No. 2,548,812 discloses a centrifugal egg separator that breaks the eggs by centrifugal force and separates yolk and albumin from the shell and “most of the chalaza”, but does not disclose a plurality of user-selectable discrete rotational speeds for performing a corresponding plurality of egg separation operations. U.S. Pat. No. 1,989,359 discloses centrifuging an albumin-salt-sugar mixture to remove air and also eggshell and membrane from the mixture. U.S. Pat. No. 2,089,215 teaches removal or destruction of chalazae in a gravity-fed canted cylindrical filter with an internal rotary scraper. U.S. Pat. No. 2,354,096 discloses a centrifugal egg shelling device that ejects the shells. U.S. Pat. No. 2,631,028 teaches separating chalazae from egg whites using a gravity-fed filter having long narrow slits.

Therefore, a need exists a centrifugal egg separator especially adapted for consumer use and capable of a variety of egg separating tasks (hereinafter, an “egg spinner”). A need also exists for an egg spinner that may alternatively be powered by a conventional food processor or may be manually powered. A need exists for an egg spinner that assists in initially breaking an egg prior to spinning A need exists for an egg spinner that can break one or more eggs by spinning A need exists for an egg spinner that can operate at a speed to efficiently separate the albumin and the yolk from the egg shell. A need exists for an egg spinner that does not powder the egg shell, nor allow egg shell into the separated portion of the egg. A need exists for an egg spinner that can separate shells and chalazae from yolks and albumin. A need exists for an egg spinner having discrete user-selectable speeds, whether push button, marked on an analog dial, or digitally controlled, for 1) separating egg albumin from yolk, shell, and chalazae; 2) separating yolk and albumin from shell and chalazae; 3) separating yolk, albumin, and chalazae from shells; 4) centrifugally breaking the eggs and separating yolk and albumin from shells and chalazae; and/or 5) centrifugally breaking the eggs and separating yolk, albumin and chalazae from shells. A need exists for an egg spinner that can break and separate eggs in under three seconds, and preferably within one second. A need exists for an egg spinner that can also serve purposes in addition to egg spinning

### OBJECTS AND FEATURES OF THE INVENTION

A primary object and feature of the present invention is to overcome the above-mentioned problems and fulfill the above-mentioned needs.

Another object and feature of the present invention is to provide an egg spinner that operates at a high enough speed to efficiently separate the albumin, chalazae, and the yolk from the egg shell. Another object and feature of the present invention is to provide an egg spinner that assists in initially breaking an egg prior to spinning Another object and feature of the present invention is to provide an egg spinner that does not powder the egg shell, nor allow egg shell to enter into the separated portion of the egg. Another object and feature of the present invention is to provide an egg spinner that may alternatively be powered by a conventional food processor or may be manually powered. Another object and feature of the present invention is to provide an egg spinner that operates at a user-selectable speed to efficiently separate the albumin and the yolk from the egg shell and the chalazae. Another object and feature of the present invention is to provide an egg spinner that has discrete user-selectable speeds, whether push-button, marked on an analog dial, or digitally controlled, for 1) separating egg albumin from yolk, shell, and chalazae; 2) separating yolk and albumin from shell and chalazae; 3) separating yolk, albumin, and chalazae from shells; 4) breaking the eggs and separating yolk and albumin from shells and chalazae; and/or 5) breaking the eggs and separating yolk, albumin and chalazae from shells. Another object of the present invention is to provide an egg spinner that can break and separate eggs in under 3 seconds and preferably in under one second.

It is an additional primary object and feature of the present invention to provide an egg spinner that is efficient, inexpensive, easy to clean, universal, and handy. Other objects and features of this invention will become apparent with reference to the following descriptions.

### SUMMARY OF THE INVENTION

In accordance with a preferred embodiment hereof, this invention provides an egg spinner comprising a centrifugal egg separator further comprising: a centrifuge basket having a maximum exterior radius and a multiply-perforated (foraminous) cylindrical basket wall, a inner screen material covering said multiple perforations, a basket floor closing the bottom of said cylindrical wall, an axial pillar extending from said basket floor, wherein said axial pillar has sufficient rigidity to assist in the breaking of an egg; a first rotatable torque drive coupling that couples a bottom of said basket floor to a top surface of a container floor, said container floor having a radius greater than said basket outer radius, a cylindrical container wall extending upward from an outer perimeter of said container floor, and a lid operable to releasably close the top of said container wall, wherein said inner screen material, said basket floor, and said axial pillar are non-abrasive to egg shell, and wherein said container floor comprises a second rotatable coupling coupled to said first rotatable coupling through said container floor, wherein said second rotatable coupling is operable to receive a drive coupling from a motorized food processor. IN an alternate embodiment, the foraminous cylindrical wall and may be made of one piece of plastic drilled to be foraminous. The egg spinner may also have an alternate lid comprising: an axial coupling extending from a bottom surface of said lid and operable to couple said lid to said axial pillar to assist in manually spinning said centrifuge basket. The egg spinner may also have an alternate lid further comprising a handle to assist with manual spinning The motor preferably has a low speed (rotational velocity) for separating the egg albumin from the yolk and egg shell and a plurality of higher speeds for separating the yolk and albumin from the egg shell. In a preferred embodiment, the egg spinner has three user-selectable speeds. At a first user-selectable speed, the albumin will separate into the container and the yolks, shells, and chalazae will remain in the centrifuge basket. The shells are manually retrieved and then the yolks and, optionally, the chalazae, are retrieved from the centrifuge basket. At a second user-selectable speed, a mixture of yolks and albumin will separate into the container and the shells and chalazae will remain in the centrifuge basket awaiting disposal. At a third user-selectable speed, the yolks, albumin, and chalazae will separate into the container and only the shell will remain in the centrifuge basket awaiting disposal. In another preferred embodiment, the egg spinner has four user-selectable speeds, the first three as already described, plus a fourth speed at which unbroken eggs in the centrifuge basket are broken, the yolk and albumin, are separated into the container and the shells and chalazae are left in the centrifuge basket. In yet another preferred embodiment, the egg spinner has five user-selectable speeds, the first four as already described, plus a fifth speed at which unbroken eggs in the centrifuge basket are cracked, the yolk, albumin, and chalazae are separated into the container and the shells are left in the centrifuge basket.

An egg spinner for separating components of poultry eggs, the egg spinner having a plurality of user-selectable discrete rotational velocities for performing a corresponding plurality of egg separation operations, the egg spinner including: a centrifuge basket including: a foraminous cylindrical wall; and an interior surface of the wall, where the interior surface is sufficiently non-abrasive to a poultry egg shell to resist powdering such egg shell during centrifuge operation; and where the centrifuge basket is able to be controllably driven to a particular rotational velocity of the plurality of user-selectable discrete rotational velocities to cause a particular component of a poultry egg within the centrifuge basket to move through the foraminous cylindrical wall, while retaining another particular component of such a poultry egg in the centrifuge basket. The egg spinner, further including a reclosable container able to: contain the centrifuge basket and to collect such a component of such a poultry egg after such a component moves through the foraminous cylindrical wall; admit a torque drive element able to rotationally drive the centrifuge basket; and support the centrifuge basket within the container while the centrifuge basket is mechanically coupled to the torque drive element. The egg spinner, where the container further includes: a lid with a chute for inserting eggs into the centrifuge basket without removing the lid; a lid with a chute for inserting a poultry egg into the centrifuge basket without removing the lid and a plunger for pushing such a poultry egg through the chute and onto a shell-breaking point of an axial pillar in the centrifuge basket; and/or a lid with a chute for inserting a poultry egg into the centrifuge basket without removing the lid and a plunger for pushing such a poultry egg through the chute and onto a shell-breaking point of an axial pillar in the centrifuge basket, where the plunger has a cavity conformally shaped to receive the shell-breaking point. The egg spinner, where the container further includes: a lid able to open and reclose the container; a lid with a locking feature; a lid adapted to enable manual rotation of the centrifuge basket; a pour spout; and/or an exterior handle. The egg spinner, further including: a motor mechanically coupled to the torque drive element; a motor controller linked to the motor and able to control the rotational velocity of the motor; and a manual input device linked to the motor controller and able to enable manual selection of a particular rotational velocity of the plurality of user-selectable discrete rotational velocities. The egg spinner, where the centrifuge basket includes an axial pillar extending from a bottom of the centrifuge basket, where the axial pillar is able to assist in manually breaking such a poultry egg upon entry of such a poultry egg into the centrifuge basket. The egg spinner, where the particular rotational velocity is a first rotational velocity of the plurality of user-selectable discrete rotational velocities able to cause only egg albumin from such a broken poultry egg to move through the foraminous cylindrical wall. The egg spinner, where the particular rotational velocity is a second rotational velocity of the plurality of user-selectable discrete rotational velocities able to cause only egg albumin and yolk from such a broken poultry egg to move through the foraminous cylindrical wall. The egg spinner, where the particular rotational velocity is a third rotational velocity of the plurality of user-selectable discrete rotational velocities able to cause only egg albumin, yolk, and chalazae from such a broken poultry egg to move through the foraminous cylindrical wall. The egg spinner, where the particular rotational velocity is a fourth rotational velocity of the plurality of user-selectable discrete rotational velocities able to first break such a poultry egg by centrifugal force and then cause only egg albumin and yolk from such a poultry egg to move through the foraminous cylindrical wall. The egg spinner, where the particular rotational velocity is a fifth rotational velocity of the plurality of user-selectable discrete rotational velocities able to first break such a poultry egg by centrifugal force and then to cause only egg albumin, yolk, and chalazae from such a poultry egg to move through the foraminous cylindrical wall. The egg spinner, further including: a motor mechanically coupled to the centrifuge basket; a motor controller linked to the motor and able to control the rotational velocity of the motor; and a manual input device linked to the motor controller and enabling manual selection of a particular rotational velocity of the plurality of user-selectable discrete rotational velocities. The egg spinner, where the foraminous cylindrical wall includes: a radially inner screen having perforations of a first size; and a radially outer support wall for circumferentially abutting and supporting the radially inner screen and having perforations of a second size, where the second size is larger than the first size. The egg spinner, further including a plurality of interchangeable the radially inner screens, where each screen of the plurality of the radially inner screens has perforations of a unique first size. The egg spinner, where the centrifuge basket includes a bottom, a top edge of the foraminous cylindrical wall, and: an axial pillar extending from the bottom; an axial pillar extending from the bottom and having a shell-fracturing point; a plurality of perforations in the bottom; a lid able be releasably attached to the top edge of the foraminous cylindrical wall; a lid able be releasably attached and to the top edge of the foraminous cylindrical wall with a seal between the top edge and the lid; a lid having an extension radially outward from the foraminous cylindrical wall; and/or an un-perforated portion of the foraminous cylindrical wall proximate the top edge.

An egg spinner for separating components of poultry eggs, the egg spinner having a plurality of user-selectable discrete rotational velocities for performing a corresponding plurality of egg separation operations, the egg spinner including: a centrifuge basket including: a foraminous cylindrical wall; and an interior surface of the wall, where the interior surface is sufficiently non-abrasive to a poultry egg shell to resist powdering such egg shell during centrifuge operation; and where the centrifuge basket is able to be controllably driven to a particular rotational velocity of the plurality of user-selectable discrete rotational velocities for performing a corresponding particular egg separation operation of the plurality of egg separation operations to cause a particular component of a poultry egg within the centrifuge basket to move through the foraminous cylindrical wall, while retaining a other particular component of such a poultry egg; where the centrifuge basket includes a foraminous bottom and an axial pillar extending from the bottom, where the axial pillar is able to assist in manually breaking such a poultry egg upon entry of such a poultry egg into the centrifuge basket. The egg spinner, further including a reclosable container: that is able to: contain the centrifuge basket and to collect such a component of such a poultry egg when such a component moves through the foraminous cylindrical wall; admit a torque drive element able to rotationally drive the centrifuge basket; and support the centrifuge basket within the container while the centrifuge basket is mechanically coupled to the torque drive element; and further including: a lid with a chute for inserting a poultry egg into the centrifuge basket without removing the lid; a lid with a chute for inserting a poultry egg into the centrifuge basket without removing the lid and a plunger for pushing such a poultry egg through the chute and onto a shell-breaking point of an axial pillar in the centrifuge basket; a lid with a chute for inserting a poultry egg into the centrifuge basket without removing the lid and a plunger for pushing such a poultry egg through the chute and onto a shell-breaking point of an axial pillar in the centrifuge basket, where the plunger has a cavity conformally shaped to receive the shell-breaking point; a lid able to open and reclose the container; a lid with a locking feature; a lid adapted to enable manual rotation of the centrifuge basket; a pour spout; and/or a shape adaptable to be used with a particular food processor. The egg spinner, further including: a motor mechanically coupled to the torque drive element; a motor controller linked to the motor and able to control the rotational velocity of the motor; and a manual input device linked to the motor controller and enabling manual selection of the a particular rotational velocity. The egg spinner, where the plurality of user-selectable discrete rotational velocities comprises: a first rotational velocity of the plurality of user-selectable discrete rotational velocities able to cause, when such a manually broken poultry egg is initially within the centrifuge basket, only egg albumin from such egg to move through the foraminous cylindrical wall; a second rotational velocity of the plurality of user-selectable discrete rotational velocities able to cause, when such a manually broken poultry egg is initially within the centrifuge basket, only egg albumin and yolk from such egg to move through the foraminous cylindrical wall; a third rotational velocity of the plurality of user-selectable discrete rotational velocities able to cause, when such a manually broken poultry egg is initially within the centrifuge basket, only egg albumin, yolk, and chalazae from such egg to move through the foraminous cylindrical wall; a fourth rotational velocity of the plurality of user-selectable discrete rotational velocities able, when such unbroken poultry egg is initially within the centrifuge basket, to first break such a poultry egg and then cause only egg albumin and yolk from such a poultry egg to move through the foraminous cylindrical wall; and a fifth rotational velocity of the plurality of user-selectable discrete rotational velocities able to first break such a poultry egg and then to cause only egg albumin, yolk, and chalazae from such a poultry egg to move through the foraminous cylindrical wall.

An egg spinner for separating components of poultry eggs, the egg spinner having a plurality of user-selectable discrete rotational velocities for performing a corresponding plurality of egg separation operations, the egg spinner including: a centrifuge basket including: a foraminous cylindrical wall; an interior surface of the wall, where the interior surface is sufficiently non-abrasive to a poultry egg shell to resist powdering such egg shell during centrifuge operation; a foraminous bottom closing the cylindrical wall; an axial pillar extending upward from the bottom, where the axial pillar is able to assist in manually breaking such a poultry egg upon entry of such a poultry egg into the centrifuge basket; a top edge of the foraminous cylindrical wall; and a non-perforated portion of the foraminous cylindrical wall proximate the top edge; where the centrifuge basket is controllable to operate at the plurality of user-selectable discrete rotational velocities for performing a corresponding plurality of egg separation operations, said velocities comprising: a first rotational velocity of the plurality of user-selectable discrete rotational velocities able to cause, when such a manually broken poultry egg is initially within the centrifuge basket, only egg albumin from such egg to move through the foraminous cylindrical wall; a second rotational velocity of the plurality of user-selectable discrete rotational velocities able to cause, when such a manually broken poultry egg is initially within the centrifuge basket, only egg albumin and yolk from such egg to move through the foraminous cylindrical wall; a third rotational velocity of the plurality of user-selectable discrete rotational velocities able to cause, when such a manually broken poultry egg is initially within the centrifuge basket, only egg albumin, yolk, and chalazae from such egg to move through the foraminous cylindrical wall; a fourth rotational velocity of the plurality of user-selectable discrete rotational velocities able, when such unbroken poultry egg is initially within the centrifuge basket, to first break such a poultry egg and then cause only egg albumin and yolk from such a poultry egg to move through the foraminous cylindrical wall; and a fifth rotational velocity of the plurality of user-selectable discrete rotational velocities able, when such unbroken poultry egg is initially within the centrifuge basket, to first break such a poultry egg and then to cause only egg albumin, yolk, and chalazae from such a poultry egg to move through the foraminous cylindrical wall.

### BRIEF DESCRIPTION OF THE DRAWINGS

The above and other objects and advantages of the present invention will become more apparent from the following description taken in conjunction with the following drawings in which:

FIG. 1 is a top plan view illustrating an exemplary centrifuge basket of an exemplary egg spinner, according to a preferred embodiment of the present invention;

FIG. 2 is a bottom plan view illustrating an exemplary centrifuge basket of an exemplary egg spinner, according to the preferred embodiment of FIG. 1;

FIG. 3 is a side elevation view illustrating an exemplary centrifuge basket of an exemplary egg spinner, according to the preferred embodiment of FIG. 1;

FIG. 4 is a top plan view through a transparent lid illustrating an exemplary egg spinner, according to a preferred embodiment of the present invention;

FIG. 5 is a cross-sectional elevation view illustrating an exemplary egg spinner, according to the preferred embodiment of FIG. 4;

FIG. 6 is a bottom plan view illustrating an exemplary egg spinner, according to the preferred embodiment of FIG. 4;

FIG. 7 is a side partial view illustrating an exemplary multiply-perforated centrifuge basket wall, according to the preferred embodiment of FIG. 4;

FIG. 8 is a depiction illustrating an exemplary egg spinner mounted on a food processor, according to the preferred embodiment of FIG. 4.

FIG. 9 is a side elevation view illustrating the exemplary egg spinner of FIG. 4 with an alternate lid for manual operation, according to a preferred embodiment of the present invention;

FIG. 10 is a side elevation view illustrating the exemplary egg spinner of FIG. 4 in a first step of use, according to a preferred embodiment of the present invention;

FIG. 11 is a side elevation view illustrating the exemplary egg spinner of FIG. 4 in a second step of use, according to a preferred embodiment of the present invention;

FIG. 12 is a side elevation view illustrating the exemplary egg spinner of FIG. 4 in a third step of use, according to a preferred embodiment of the present invention;

FIG. 13 is a side elevation view illustrating the exemplary egg spinner of FIG. 4 in a fourth step of use, according to a preferred embodiment of the present invention;

FIG. 14 is a side elevation diagrammatic view illustrating another exemplary embodiment of the exemplary egg spinner and defining cross-section A-A′, according to a preferred embodiment of the present invention;

FIG. 15 is a side elevation view illustrating an axial pillar of the exemplary embodiment of an egg spinner of FIG. 14 and defining view planes B-B′ and C-C′ as well as cross-section D-D′, according to a preferred embodiment of the present invention;

FIG. 16 is a view top plan view from plane B-B′ illustrating details of the axial pillar of FIG. 15 of the exemplary embodiment of an egg spinner of FIG. 14, according to a preferred embodiment of the present invention;

FIG. 17 is a view top plan view from plane C-C′ illustrating details of the axial pillar of FIG. 15 of the exemplary embodiment of an egg spinner of FIG. 14, according to a preferred embodiment of the present invention;

FIG. 18 is a view cross-sectional view of section D-D′ illustrating details of the axial pillar of FIG. 15 of the exemplary embodiment of an egg spinner of FIG. 14, according to a preferred embodiment of the present invention;

FIG. 19 is cross-sectional elevation view of section A-A′ illustrating details of the axial pillar of FIG. 15 of the exemplary embodiment of an egg spinner of FIG. 14, according to a preferred embodiment of the present invention;

FIG. 20 is a bottom plan view illustrating a lid of an exemplary centrifuge basket of the exemplary egg spinner of FIG. 14, according to a preferred embodiment of the present invention;

FIG. 21 is a bottom plan view illustrating a partially perforated bottom of an exemplary centrifuge basket of the exemplary egg spinner of FIG. 14, according to a preferred embodiment of the present invention;

FIG. 22 is a top plan view illustrating a lid of an exemplary container of the exemplary egg spinner of FIG. 14, according to a preferred embodiment of the present invention;

FIG. 23 is a side cross-sectional view illustrating an exemplary alternate embodiment of the exemplary embodiment of FIG. 4, according to a preferred embodiment of the present invention;

FIG. 23 is a side cross-sectional view illustrating the exemplary alternate embodiment of FIG. 23 in a second position, according to a preferred embodiment of the present invention;

FIG. 25 is a side cross-sectional view illustrating the exemplary alternate embodiment of FIG. 23 in a third position, according to a preferred embodiment of the present invention;

FIG. 26 is a side cross-sectional view illustrating the exemplary alternate embodiment of FIG. 23 in a fourth position, according to a preferred embodiment of the present invention;

FIG. 27 is a side elevation view illustrating a perforation pattern for the centrifuge basket of the exemplary egg spinner of FIG. 23, according to a preferred embodiment of the present invention; and

FIG. 28 is a side cross-sectional view illustrating another exemplary alternate embodiment of the exemplary embodiment of FIG. 4, according to a preferred embodiment of the present invention; and

FIG. 29 is a side cross-sectional view illustrating yet another exemplary alternate embodiment of the exemplary embodiment of FIG. 4, according to a preferred embodiment of the present invention.

### DETAILED DESCRIPTION OF THE BEST MODES AND PREFERRED EMBODIMENTS OF THE INVENTION

“Centrifuge basket” as defined and used herein, refers to a spinnable cylindrical container, closed or foraminous on the bottom, having multiple perforations in the cylindrical wall.

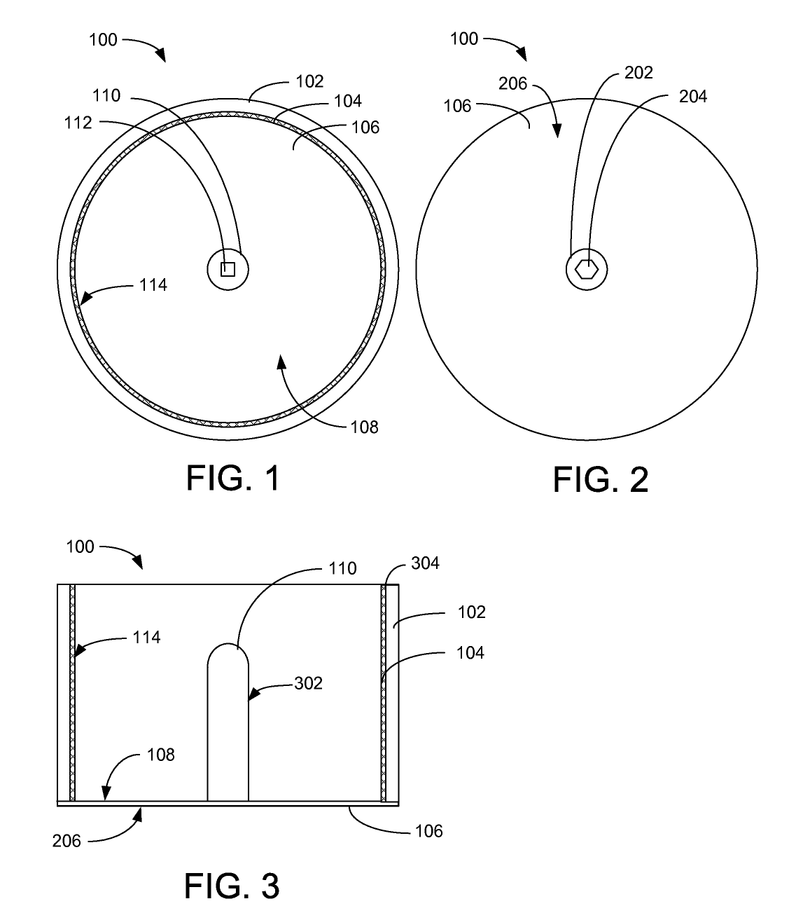

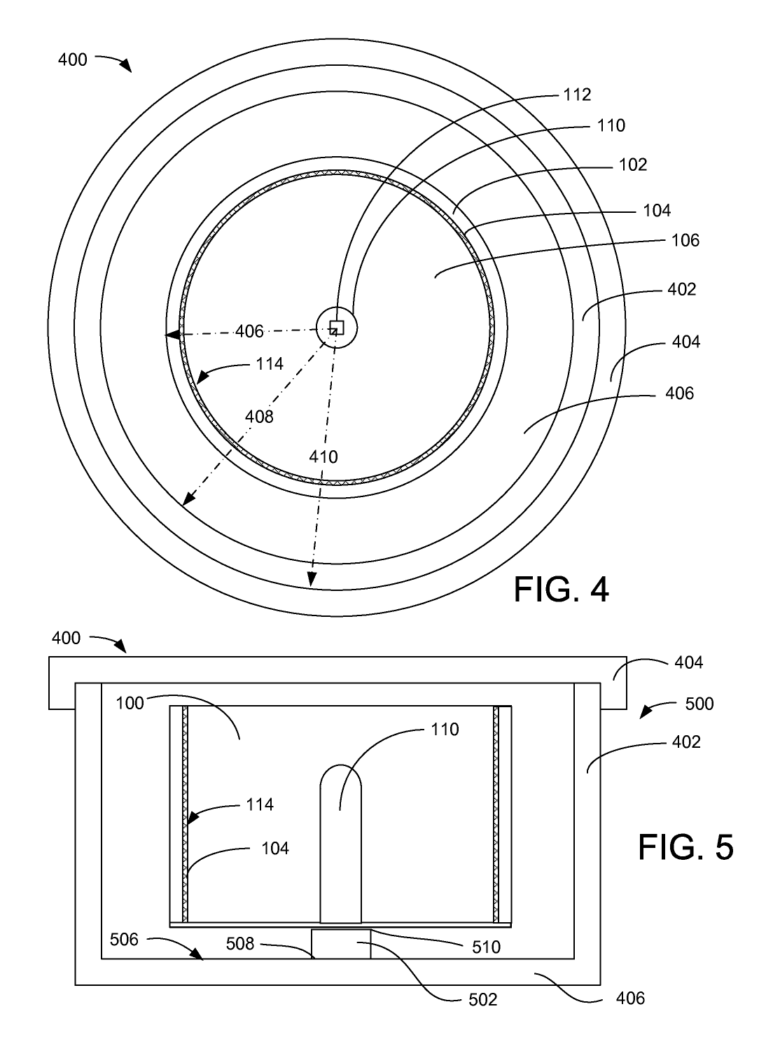

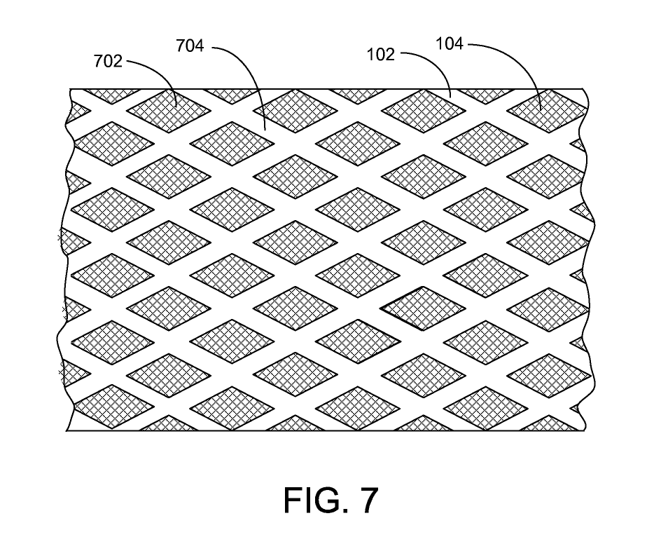

FIG. 1 is a top plan view illustrating an exemplary centrifuge basket 100 of an exemplary egg spinner 400 (see FIG. 4), according to a preferred embodiment of the present invention. Centrifuge basket 100 includes a basket floor 106 with a top surface 108, a cylindrical basket wall 102 with multiple perforations 702 (see FIG. 7), an inner screen 104 forming an internal lining of basket wall 102 and covering the perforations 702, an axial pillar 110 having a torque coupling 112 proximate the top of axial pillar 110. Variation in the size of axial pillar 110, thickness of basket wall 102, and thickness of inner screen 104 is within the scope of the present invention. Internal surface 114 of inner screen 104 and top surface 108 of basket floor 106 are preferably not abrasive to egg shell. In an alternate embodiment, inner screen 104 and basket wall 102 may be of single-piece construction. In a particular embodiment, the basket floor 106 may have perforations. In another alternate embodiment, the basket floor 106, inner screen 104, and basket wall 102 may be of single-piece construction.

FIG. 2 is a bottom plan view illustrating an exemplary centrifuge basket 100 of an exemplary egg spinner 400 (see FIG. 4), according to the preferred embodiment of FIG. 1. Bottom surface 206 of basket floor 106 houses basket floor axial torque coupling 202 with a polygonal (shown as square) opening 204 for receiving a torque drive coupling 502 (see FIG. 5). Various shapes of polygonal opening 204 may be used, within the constraint of being able to receive a torque drive coupling 502. In a particular embodiment, polygonal opening 204 may be almost as deep as axial pillar 110 is long.

FIG. 3 is a side elevation view illustrating an exemplary centrifuge basket 100 of an exemplary egg spinner 400 (see FIG. 4), according to the preferred embodiment of FIG. 1. Axial pillar 110 may be of various heights and has a surface 302 that is not abrasive to egg shell.

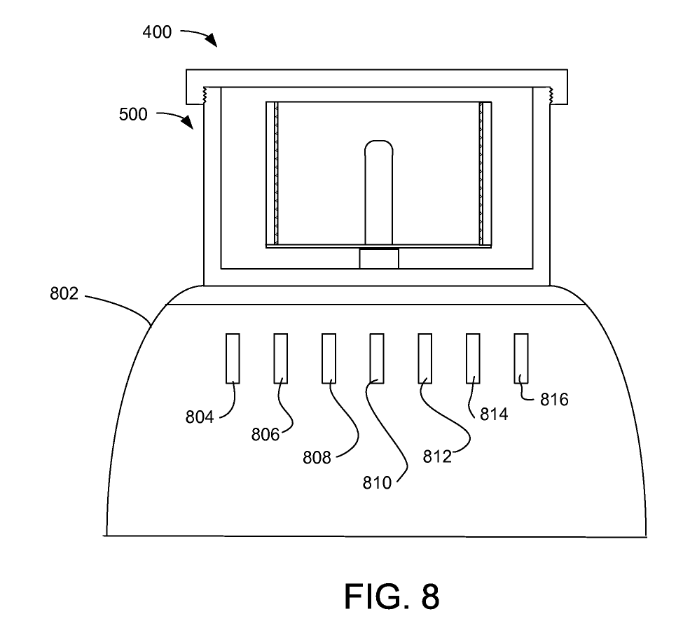

FIG. 4 is a top plan view through a transparent lid 404 illustrating an exemplary egg spinner 400, according to a preferred embodiment of the present invention. Lid 404 is shown as transparent for purposes of illustration: the invention is not so limited. Container wall 402 extends upward around the perimeter of container floor 406. The inner radius 408 of container wall 402 is greater than the outer radius 406 of centrifuge basket 100. Lid 404 is shown extending radially outside of container wall 402. In other embodiments, the lid 404 may not extend radially beyond the container wall 402. Container wall 402 has a base outer radius 410 adapted to fit in a conventional food processor 802 (see FIG. 8). Seals and grommets (not shown) between the lid 404 and the container wall 402 may be used to improve containment of the liquid egg components. Lid 404 opens and recloses reclosable container 500.

FIG. 5 is a cross-sectional elevation view illustrating an exemplary egg spinner 400, according to the preferred embodiment of FIG. 4. Centrifuge basket 100 rotates within reclosable container 500 supported on torque drive coupling 502, which extends from the top surface 506 of container floor 406. Reclosable container 500 includes container floor 406, container wall 402, torque drive coupling 502, and lid 404. Reclosable container 500 collects egg components which pass through the foraminous centrifuge wall 104. Torque drive coupling (or element) 502 prevents the passage of liquids through the lower joint 508 with the container floor 406 and resists the passage of liquids through the upper joint 510 with the centrifuge basket 100, while transmitting torque from a motor, such as that in a conventional food processor 802. In a preferred embodiment, torque drive coupling 502 includes a vertical extension, or drive shaft, into polygonal opening 204. In an alternate embodiment, reclosable container 500 may have a manually operable drain (not shown) in container wall 402 or container floor 406.

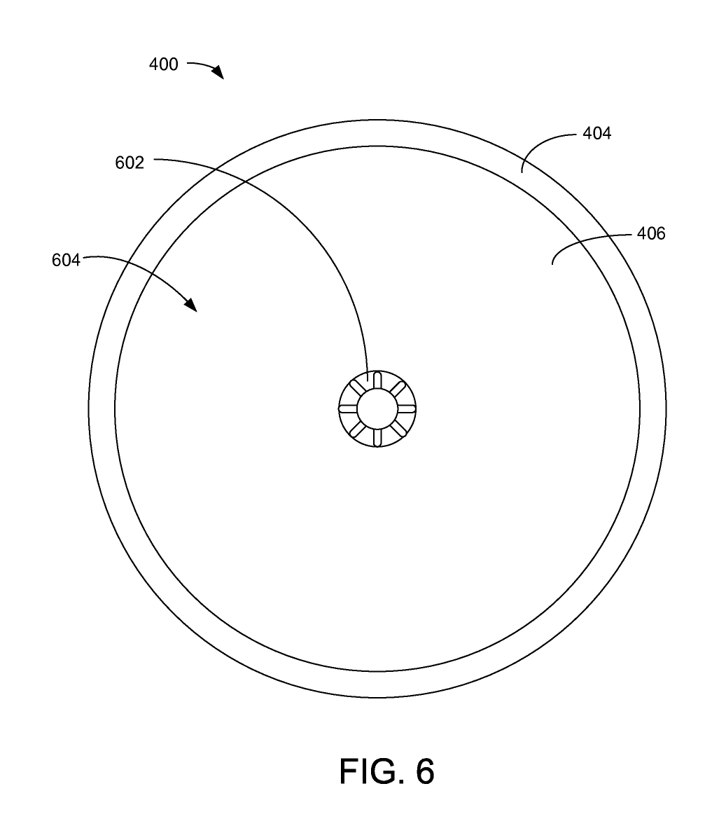

FIG. 6 is a bottom plan view illustrating an exemplary egg spinner 400, according to the preferred embodiment of FIG. 4. Container floor 406 has a torque fitting 602 for receiving a complimentary torque fitting from a motorized food processor 802 (See FIG. 8). Torque fitting 602 is coupled, through container floor 406, to torque drive coupling 502. In various alternate embodiments, torque fitting 602 may be of various complimentary shapes, adapted to corresponding various torque drives associated with various food processor motors. In a particular embodiment, the egg spinner 400 may be sold with various adapters for interfacing with various models of commercially available food processor motors.

FIG. 7 is a side partial view illustrating an exemplary multiply-perforated (foraminous) centrifuge basket 100 wall 102, according to the preferred embodiment of FIG. 4. Basket wall 102 is shown as a diagonal latticework 704 around diamond-shaped perforations 702 (one labeled) supporting, against centrifugal forces, inner screen 104. Perforations in the inner screen 104 are always smaller than perforations 702. In alternate embodiments, perforations 702 may be of various shapes and sizes, within the functional constraints of the invention. In an alternative embodiment, inner screen 104 may be one of a plurality of interchangeable inner screens 104, each having screen perforations uniquely sized and shaped.

FIG. 8 is a depiction illustrating an exemplary egg spinner 400 mounted in reclosable container 500 on a food processor 802, according to the preferred embodiment of FIG. 4. The outer base radius 402 is sized to fit the base of at least one brand of food processor 802, such as a household kitchen appliance known as a “blender”. In various embodiments adapted to various designs of conventional food processors 802, the base outer radius 410 and the shape and contour of reclosable container 500 may be adapted (by design) to fit. In a preferred embodiment, food processor 802 may have user-selectable speeds for various egg-spinning tasks. For example, button 804 may be for separating albumin from yolk, chalazae, and shell; button 806 may be for separating albumin and yolk from chalazae and shell; button 808 may be for separating albumin, yolk, and chalazae from shell; button 810 may be for breaking eggs and separating yolk and albumin from shell and chalazae; and button 812 may be for breaking eggs and separating yolk, albumin, and chalazae from shell. Buttons 814 and 816 may be for other food centrifuge tasks. The arrangement of buttons 804, 806, 808, 810, 812, 814, and 816 on the food processor 802 is not intended to be limiting. Likewise, an analog dial for controlling speed, with markings for particular speeds for particular tasks, may be used instead of buttons 804, 806, 808, 810, 812, 814, and 816. In various other preferred embodiments, other speed control systems may be used, such as digital control. The food processor 802 includes a motor mechanically coupled to a torque drive element (such as 502), a motor controller linked to the motor and able to control the rotational velocity of the motor, and a manual input device (804, 806, 808, 810, 812) enabling manual selection of a discrete rotational velocity.

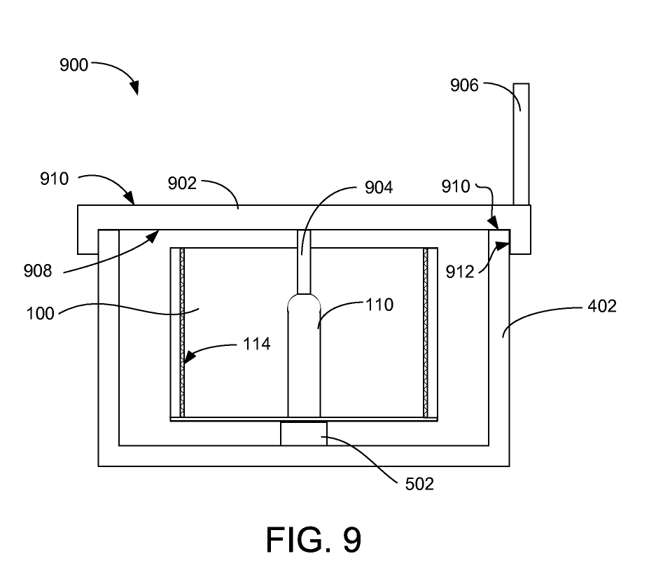

FIG. 9 is a side elevation view illustrating an exemplary egg spinner 900 having a different lid 902, for manual operation, than the lid 404 of FIG. 4, according to a preferred embodiment of the present invention. Lid 902 rotationally engages container wall 402 on a top surface 910 and an outer container wall 402 surface 912. A mechanical torque linkage 904 extends from a bottom surface 908 and couples lid 902 to axial pillar 110, so that the centrifuge basket 100 rotates in response to the lid 902 being rotated. The mechanical linkage 902 shown is a simple axle inserted into torque coupling 112. In other embodiments, more complicated mechanical linkages 904, such as those known in the expired prior art of salad spinners, may be used. Optionally, handle 906 may extend from lid 902 above top lid surface 910 to assist in manual egg spinning.

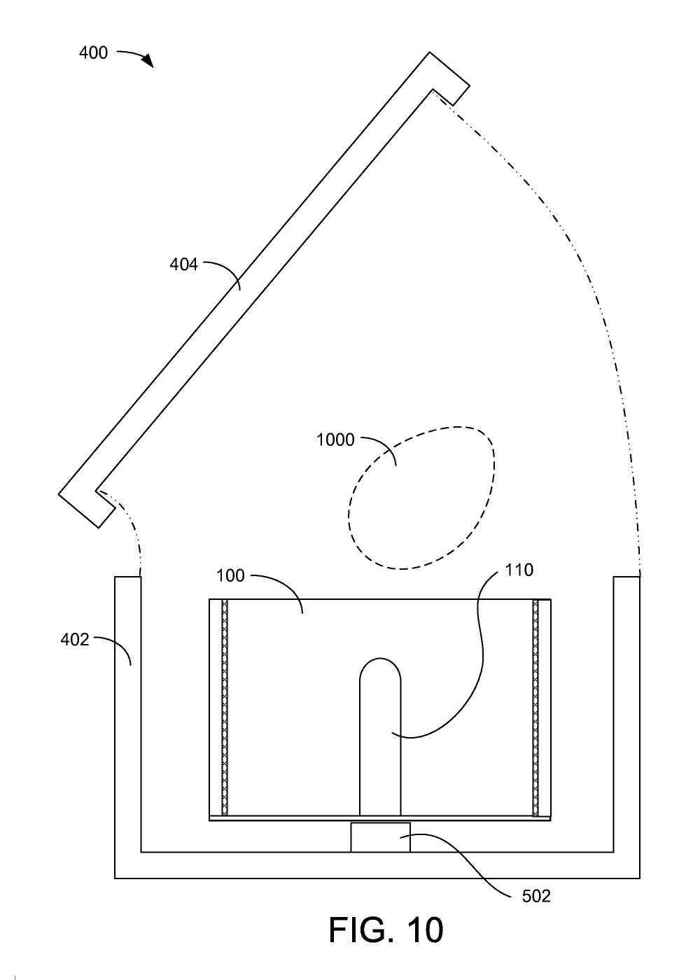

FIG. 10 is a side elevation view illustrating the exemplary egg spinner 400 of FIG. 4 in a first step of use, according to a preferred embodiment of the present invention. The lid 404 is removed to insert poultry egg 1000 into centrifugal basket 100. In preferred embodiments, a plurality of eggs may be spun concurrently, but only one is shown for simplicity of illustration.

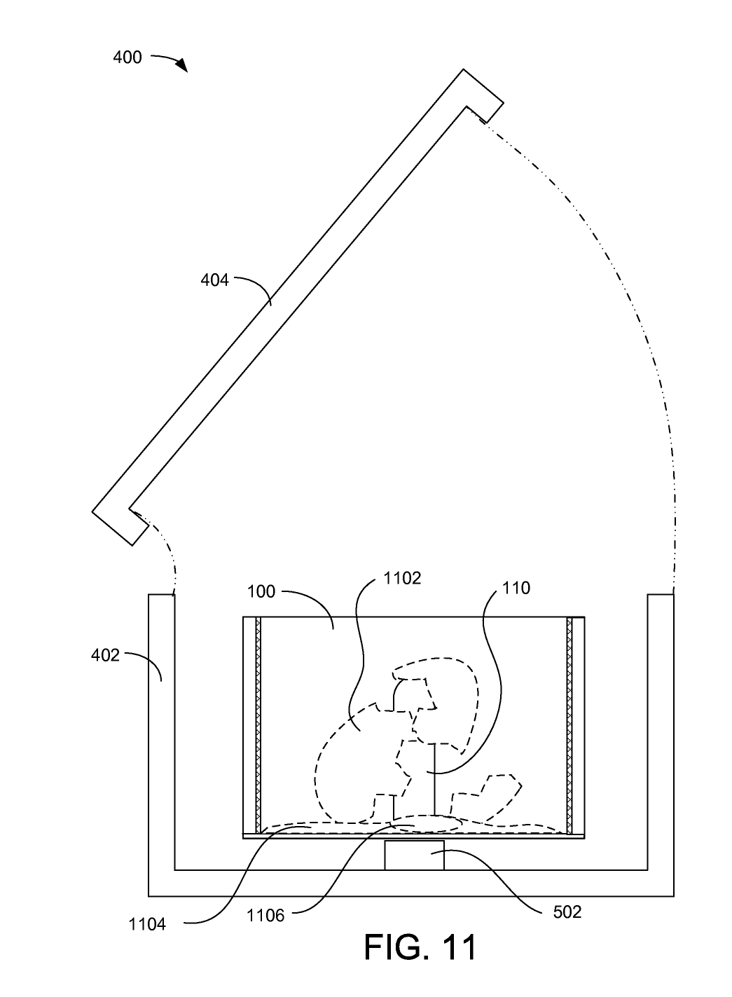

FIG. 11 is a side elevation view illustrating the exemplary egg spinner 400 of FIG. 4 in a second step of use, according to a preferred embodiment of the present invention. The egg 1000 is broken over axial pillar 110, leaving wet pieces of egg shell 1102 (one labeled) and a puddle containing at least some of the yolk 1106 and albumin 1104. It is not essential that the yolk 1106 remain intact after the egg 1000 is broken, unless only albumin 1104 is to be separated.

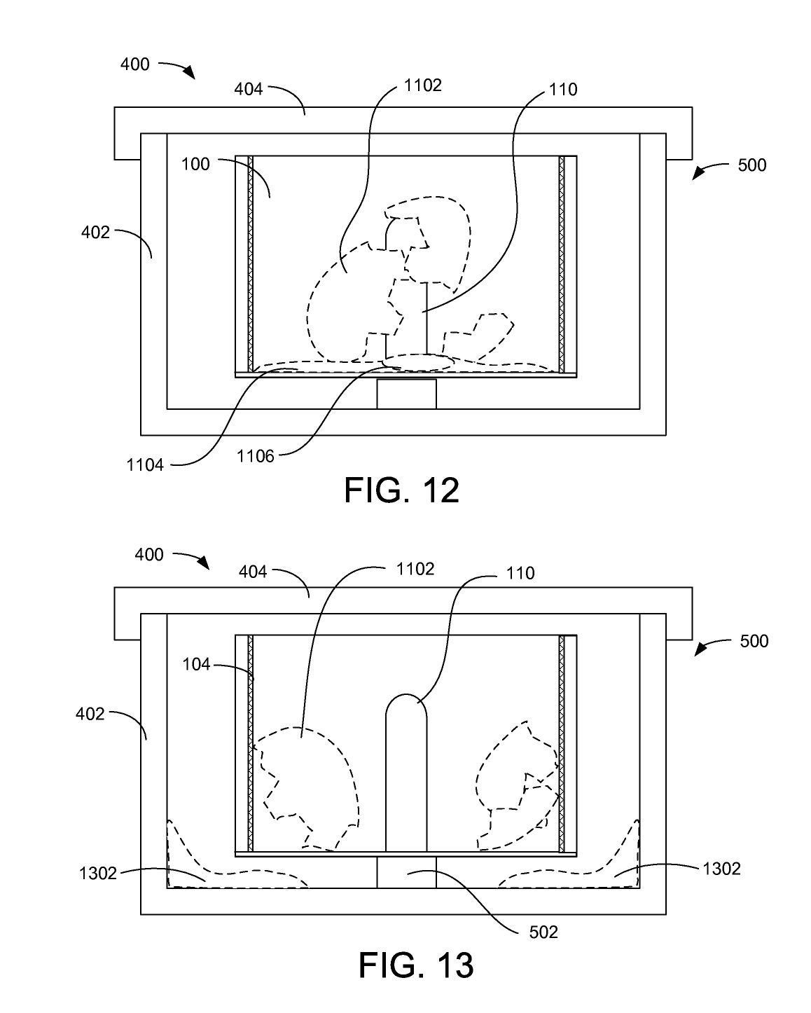

FIG. 12 is a side elevation view illustrating the exemplary egg spinner 400 of FIG. 4 in a third step of use, according to a preferred embodiment of the present invention. The lid 404 is replaced and, in some embodiments, fastened, to container wall 402.

FIG. 13 is a side elevation view illustrating the exemplary egg spinner of FIG. 4 in a fourth step of use, according to a preferred embodiment of the present invention. After spinning, the mixed yolk and albumin 1302 is in the container 500 by virtue of having been strained through inner screen 104 by centrifugal force. The egg shells 1102 (one labeled), are substantially free of yolk 1106 and albumin 1104. The lid 404 can now be removed, the centrifuge basket 100 lifted out, and the mixed egg yolk and albumin 1302 can be poured out into any recipe calling for egg. Both the container 500 and the centrifuge basket 100 may be hand or machine washed. The extent to which the mixed egg yolk and albumin 1302 are mixed may be varied as a function of centrifuge speed. At high speeds, the yolk 1106 and the albumin 1104 are thoroughly mixed, while lower speeds result in less mixing. At a particular low speed, and with the egg shell 1102 absent, an intact yolk 1106 may be retained inside the centrifuge basket 100 and only the egg albumin 1104 leaves the centrifuge basket 100.

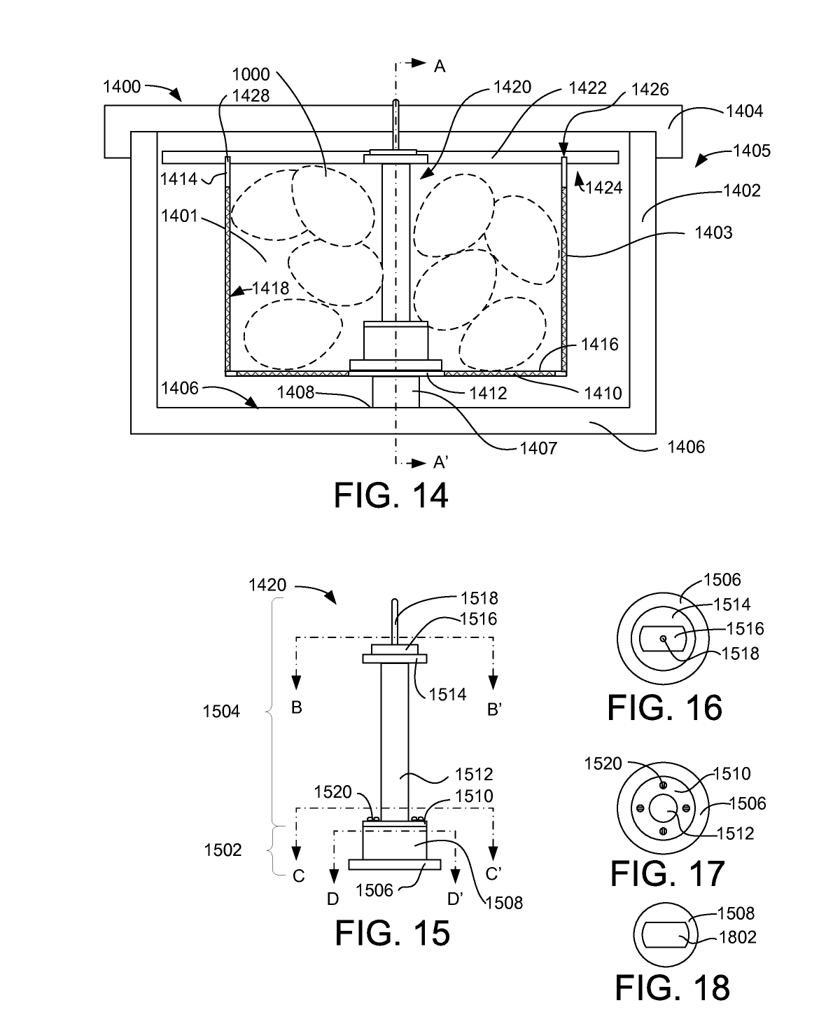

FIG. 14 is a side elevation diagrammatic view illustrating another exemplary embodiment of the exemplary egg spinner 1400 and defining cross-section A-A′, according to a preferred embodiment of the present invention. Egg spinner 1400 is a larger model (not shown to scale relative to other drawings) that can receive a plurality of whole raw avian eggs 1000 (one of eight labeled) and reach speeds sufficient to break the eggs 1000 and extract the albumin and yolk mixture into the outer container 1405 while leaving the egg shells in the centrifuge basket 1401, all within a matter of one-to-three seconds. This feature is particularly useful when making omelets and quiche. Also, when making scrambled eggs or similar dishes from quail's eggs, the tedious job of breaking many small eggs individually is made fast and simple. Centrifuge basket 1401 has a unitary foraminous cylindrical wall 1403 and a bottom 1416 with a foraminous portion 1410 and a non-perforated portion 1412. The interior surface 1418 of foraminous wall 1403 is sufficiently non-abrasive to a poultry egg shell 1102 to resist powdering such egg shell during centrifuge operation. Centrifuge basket 1401 has a basket lid 1422 which releasably fixes on the top edges 1428 of unitary foraminous cylindrical wall 1403 and releasably fixes on a lid support 1514 (see FIG. 15). Channel 1426 receives the top edge of basket wall 1403 and may include a seal and/or a locking or latching mechanism that works in concert with adaptations for basket wall 1403. In an alternate embodiment, seals may be provided between the basket lid 1422 and the top edges 1428 of unitary foraminous cylindrical wall 1403 and/or on the lid support 1514. Basket lid 1422 has an overhang, or extension, 1424 that, along with un-perforated portion 1414 of basket wall 1403, assists in reducing spray onto the underside of container lid 1404.

Centrifuge basket 1401 also has an axial pillar 1420, discussed in greater detail below. Centrifuge basket 1401 is supported by torque drive coupling 1407. Torque drive coupling 1407 prevents the passage of liquids through the lower joint 1408 with the container floor 1406 and resists the passage of liquids through the upper joint with the centrifuge basket 1401, while transmitting torque from a motor, such as one found in a conventional or commercial food processor 802. Outer container 1405 has a bottom 1406, a cylindrical wall 1402, and a releasable container lid 1404.

FIG. 15 is a side elevation view illustrating an axial pillar 1420 of the exemplary embodiment of an egg spinner 1400 of FIG. 14 and defining view planes B-B′ and C-C′ as well as cross-section D-D′, according to a preferred embodiment of the present invention. Axial pillar 1420 has a pedestal 1502 and a pillar 1504. Pedestal 1502 includes a pillar support 1508 with a flange 1506. Pillar 1504 is a unitary object in which metal alignment dowel 1518 is co-molded on plastic that forms the remainder of the pillar 1504. Pillar 1504 includes a base 1510, axle 1512, lid support 1514, lid engagement device 1516, and alignment dowel 1518. Base 1510 of pillar 1504 attaches to pillar support 1508, preferably with screws 1520 or similar fasteners.

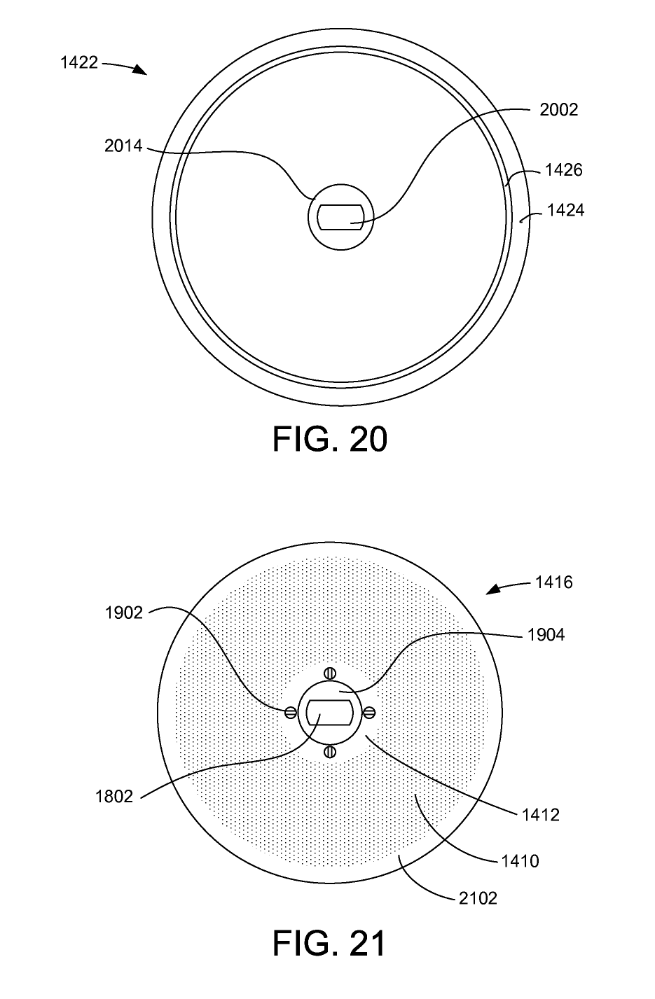

FIG. 16 is a top plan view from plane B-B′ illustrating details of the axial pillar 1420 of FIG. 15 of the exemplary embodiment of an egg spinner 1400 of FIG. 14, according to a preferred embodiment of the present invention. The pattern of screws 1520 or other fasteners securing base 1510 to pillar support 1508 of pedestal 1502 may be varied to include fewer or more screws 1520 or other fasteners. Lid engagement device 1516 is not radially symmetrical an fits into a complimentary opening in the lid (see FIG. 20), enabling lid engagement device 1516 to apply torque to the basket lid 1422 to maintain the circular velocity of the basket lid 1422 even with the circular velocity of the centrifuge basket 1401. Lid support 1514 supports a portion of the basket lid 1422 around the lid engagement device 1516. Flange 1506 is visible in this view.

FIG. 17 is a view top plan view from plane C-C′ illustrating details of the axial pillar 1420 of FIG. 15 of the exemplary embodiment of an egg spinner 1400 of FIG. 14, according to a preferred embodiment of the present invention. The pattern of screws 1520 or other fasteners securing base 1510 to pillar support 1508 of pedestal 1502 may be varied to include fewer or more screws 1520 or other fasteners.

FIG. 18 is a cross-sectional view of section D-D′ illustrating details of the axial pillar 1420 of FIG. 15 of the exemplary embodiment of an egg spinner 1400 of FIG. 14, according to a preferred embodiment of the present invention. Torque drive cavity 1802 in pillar support 1508 is adapted to receive a torque drive from a food processor or functional substitute, such as a dedicated torque drive. Cavity 1802 may be shaped as shown or, in various embodiments, may be of various shapes that are functional for receiving particular torque drives.

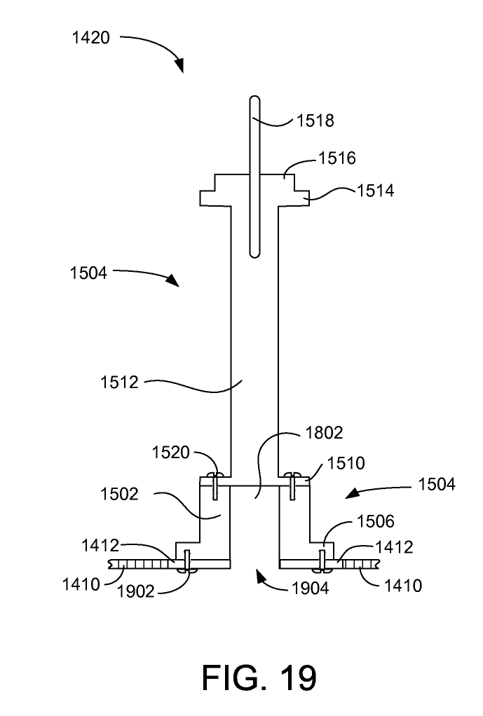

FIG. 19 is cross-sectional elevation view of section A-A′ illustrating details of the axial pillar 1420 of FIG. 15 of the exemplary embodiment of an egg spinner 1400 of FIG. 14, according to a preferred embodiment of the present invention. Pillar 1504 is preferably a single piece of plastic co-molded around metal alignment dowel 1518, as shown. Pillar 1504 is preferably fastened to pedestal 1502 with fasteners 1520 (one of two labeled), shown as screws.

In an alternate embodiment, pillar 1504 and pedestal 1502 may be of single-piece construction. Pedestal 1502 is secured to the non-perforated portion 1412 of centrifuge basket 1401 with fasteners 1902 (one of two labeled), shown as screws. Circular opening 1904 leads to torque drive cavity 1802.

FIG. 20 is a bottom plan view illustrating a basket lid 1422 of an exemplary centrifuge basket 1401 of the exemplary egg spinner 1400 of FIG. 14, according to a preferred embodiment of the present invention. Complimentary opening 2002 in basket lid 1422 is sized and shaped to be a complimentary receiver of lid engagement device 1516. In various embodiments, lid engagement device 1516 and complimentary opening 2002 may be of various complimentary shapes. Indentation 2014 receives lid support 1514.

FIG. 21 is a bottom plan view illustrating a partially perforated bottom 1410, 1412 of an exemplary centrifuge basket 1401 of the exemplary egg spinner 1400 of FIG. 14, according to a preferred embodiment of the present invention. A non-perforated peripheral portion 2102 accommodates unitary foraminous cylindrical wall 1403.

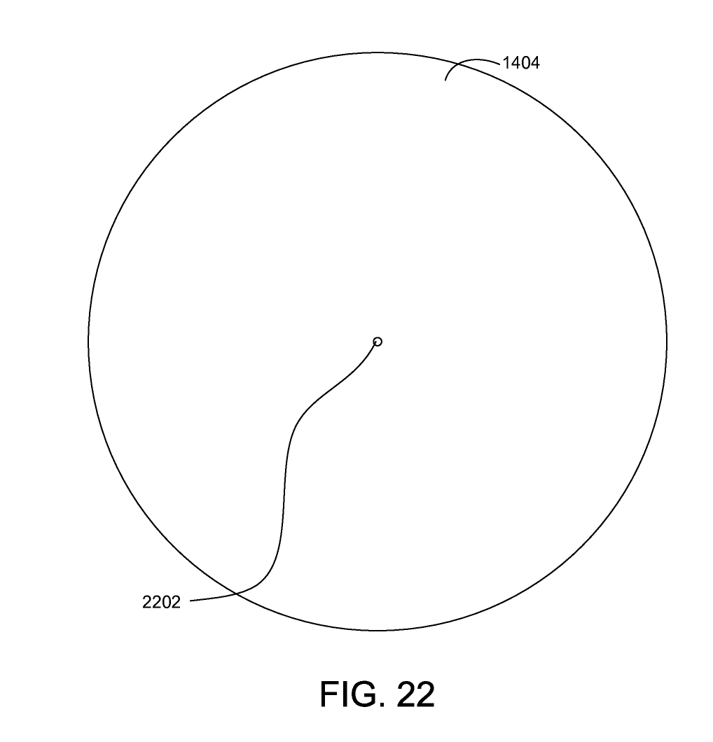

FIG. 22 is a top plan view illustrating a container lid 1404 of an exemplary container 1405 of the exemplary egg spinner 1400 of FIG. 14, according to a preferred embodiment of the present invention. Central opening 2202 accommodates metal alignment dowel 1518.

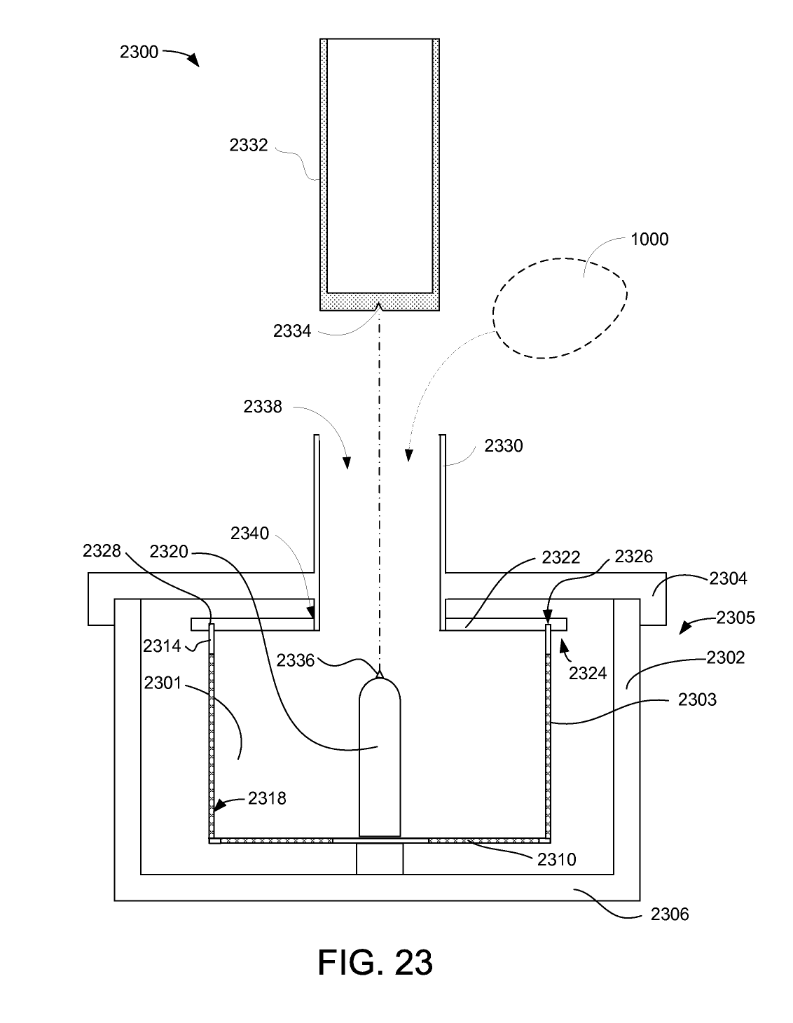

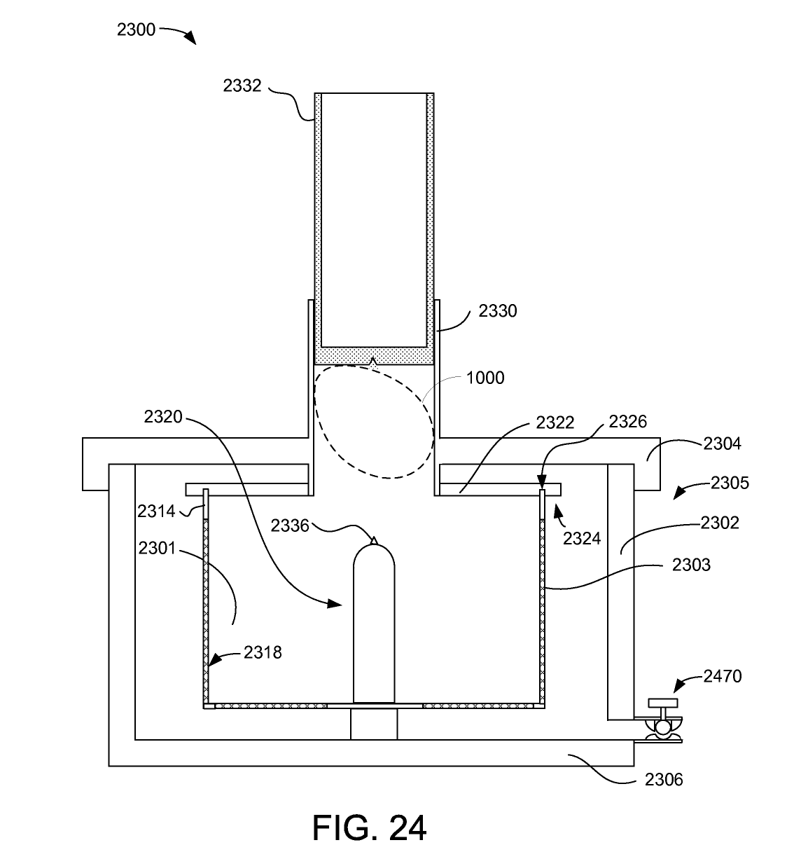

FIG. 23 is a side cross-sectional view illustrating an exemplary alternate embodiment 2300 of the exemplary egg spinner 400 of FIG. 4, according to a preferred embodiment of the present invention. The embodiment of FIG. 23 is a small egg spinner, like the egg spinner 400 of FIG. 4, but with a chute 2330 and plunger 2332 for inserting and breaking eggs 1000 serially. Container 2305 has floor 2306, cylindrical wall 2302, and container lid 2304. Container lid 2304 incorporates chute 2330 which extends into centrifuge basket 2301 through basket lid 2322. Container lid 2304 preferably has a seal (not shown) and a locking mechanism (not shown) for keeping container lid 2304 on container wall 2302 during operation. In operation, centrifuge basket 2301 and basket lid 2322 rotate and container lid 2304 with chute 2330 does not rotate. The joint 2340 between the rotating basket lid 2322 and the chute 2330 is a rotational slip joint 2340. Centrifuge lid 2322 has a circular channel 2326 for receiving the top edge of 2314 of centrifuge basket 2301. In a particular embodiment, the channel 2326 may include a seal. Cylindrical wall 2303 of centrifuge basket has an un-perforated top portion 2314 that, together with basket lid 2322 with extension 2324, reduces spray of egg yolk and albumin onto the underside of container lid 2304. The interior surface 2318 of foraminous wall 2303 is sufficiently non-abrasive to a poultry egg shell 1102 to resist powdering such egg shell during centrifuge operation.

Axial pillar 2320 has a shell-fracturing point 2336 for initiating fracture of the egg 100 shell, and is centrally aligned with the chute 2338. Manually operated plunger 2332 has an indentation conformally shaped to receive the shell-fracturing point 2336. The plunger 2332 is cylindrical and sized to slidingly engage the inside walls of the chute 2330. Plunger 2332 is long enough to rest on axial pillar 2320 and still extend above the top of chute 2330. In various alternate embodiments, handles or similar features to make the plunger 2332 easier to manually operate may extend from the plunger 2332.

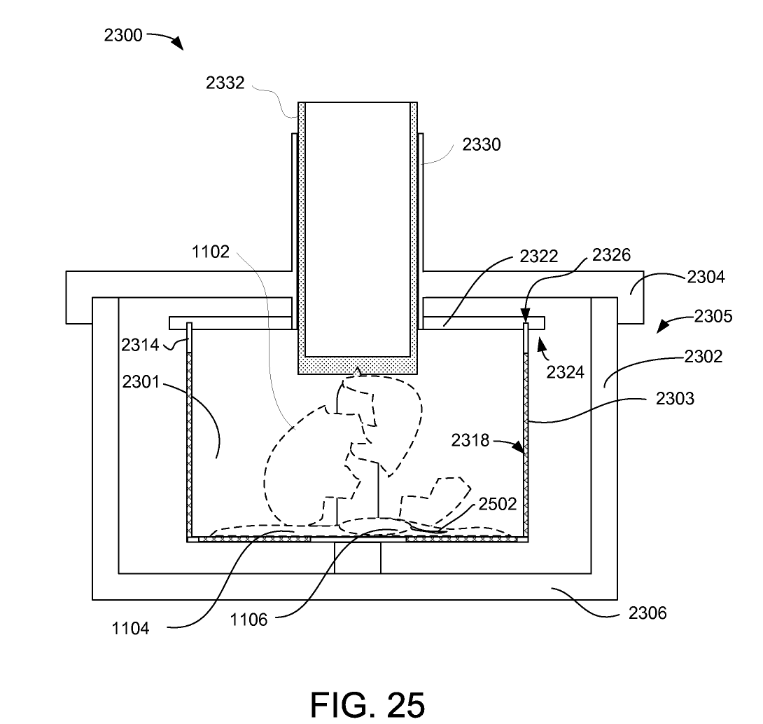

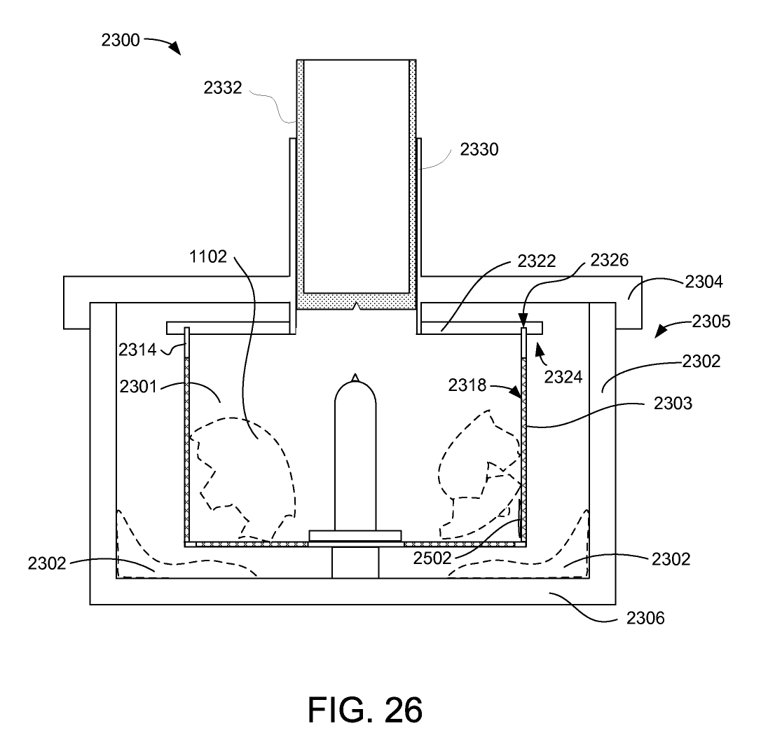

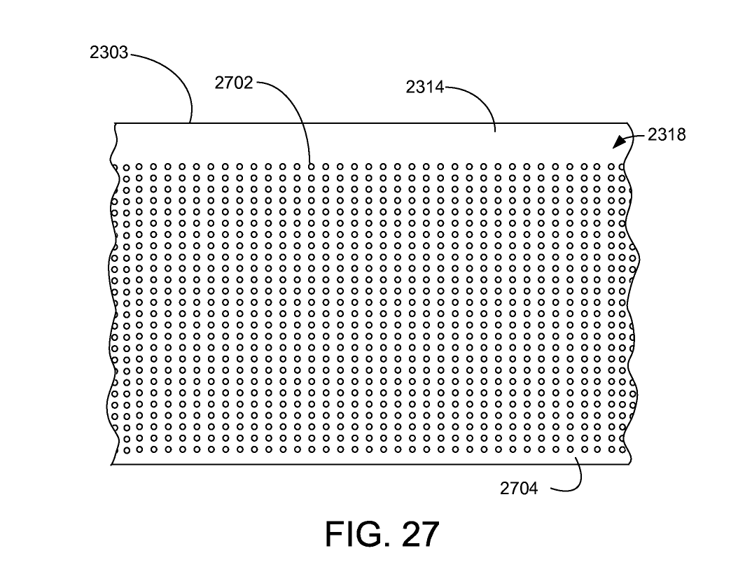

In operation, the plunger 2332 is removed from chute 2332 and egg 1000 is inserted through opening 2338 at the top of chute 2330. Plunger 2332 is then inserted into chute 2330 through opening 2338 to manually force the egg 1000 against shell-fracturing point 2336. The process is repeated for as many eggs as the centrifuge basket 2303 may hold and are desired by the user, and then the broken eggs 1000 are spun. At a first user-selectable speed, the albumin will separate into the container 2305 and the yolks 1106, shells 1102, and chalazae 2502 will remain in the centrifuge basket. The shells 1102 are manually retrieved and then the yolks 1106, with chalazae 2502, are poured out. At a second user-selectable speed, a mixture of yolks 1106 and albumin 1104 will separate into the container 2305 and the shells 1102 and chalazae 2502 (See FIG. 25 and FIG. 26) remain in the centrifuge basket 2303. At a third user-selectable speed, a mixture of yolks 1106, albumin 1104 chalazae 2502 (See FIG. 25 and FIG. 26) will separate into the container 2305 and the shells 1102 will remain in the centrifuge basket 2303. Lids 2322 and 2304 may be removed to enable unbroken eggs 1000 to be inserted into centrifuge basket 2301. With the lids 2322 and 2304 reinstalled, the user may select a fourth rotational speed that breaks the eggs 1000 with centrifugal force and causes the yolks 1106 and albumin 1104 to separate through the foraminous basket wall 2303 and into the container 2305, or a fifth rotational speed that breaks the eggs 1000 by centrifugal force and causes the yolks 1106, albumin 1104, and chalazae 2502 to separate through the foraminous basket wall 2303 and into the container 2305.

FIG. 24 is a side cross-sectional view illustrating the exemplary alternate embodiment 2300 of FIG. 23 in a second position, according to a preferred embodiment of the present invention. Here, an egg 1000 is in the chute 2330 and the plunger 2332 has been manually inserted into the chute 2330. Egg Spinner 2300 is shown with an optional container drain valve 2470, shown open, although it would normally be closed at the illustrated stage of operation. Valve 2470 should be capable of being biased open for cleaning in automatic dish-washing machines.

FIG. 25 is a side cross-sectional view illustrating the exemplary alternate embodiment 2300 of FIG. 23 in a third position, according to a preferred embodiment of the present invention. Plunger 2332 has been manually forced against egg 1000 to break the shell against shell-fracturing point 2336. Shell 1102, albumin 1104, yolk 1106, and chalazae 2502 are within the centrifuge basket 2301. Plunger 2332 is in contact with axial pillar 2320 after forcing egg 1000 against the shell-fracturing point 2336.

FIG. 26 is a side cross-sectional view illustrating the exemplary alternate embodiment 2300 of FIG. 23 in a fourth position, according to a preferred embodiment of the present invention. Plunger 2332 is withdrawn from contact with the axial pillar 2320, and the centrifuge basket 2301 is spun by a torque drive as in previously described embodiments. Here, a mixture 2302 of yolk 1106 and albumin 1104 have separated into the container, leaving shells 1102 and chalazae 2502 inside the centrifuge basket 2301.

At a first user-selectable speed, the albumin 1104 will separate into the container 2305 and the yolks 1106, shells 1102, and chalazae 2502 will remain in the centrifuge basket 2301. The shells 1102 are manually retrieved and then the yolks 1106 and, optionally, the chalazae 2502, are retrieved from the centrifuge basket 2301. At a second user-selectable speed, a mixture 2302 of yolks 1106 and albumin 1104 will separate into the container 2305 and the shells 1102 and chalazae 2502 will remain in the centrifuge basket 2301 awaiting disposal. At a third user-selectable speed, the yolks 1106, albumin 1104, and chalazae 2502 will separate into the container 2305 and only the shell 1102 will remain in the centrifuge basket 2301 awaiting disposal.

For any of the exemplary embodiments, the first, second, and third user-selectable speeds will depend on the size of the centrifuge basket 2301 and the size and spacing of the perforations in the basket wall 2302. For egg spinner 2300, the perforations are approximately one millimeter in diameter with one to one-and-a-half millimeter spacing.

An embodiment large enough to fit eggs 1000 between the axial pillar 1420 and the basket wall 1403 may have fourth and fifth user-selectable speeds to crack the eggs 1000 by centrifugal force.

In a particular embodiment, the container 2305 may be equipped with a pour spout and a lid adapted to the presence of a pour spout.

FIG. 27 is a side elevation view illustrating a perforation pattern for the basket wall 2303 of the exemplary egg spinner 2300 of FIG. 23, according to a preferred embodiment of the present invention. Perforations 2702 are round holes arranged in rows and columns around the basket wall 2303. A top un-perforated portion 2314 assists in reducing spray onto the underside of container lid 2304. Bottom un-perforated portion accommodates the basket floor 2310.

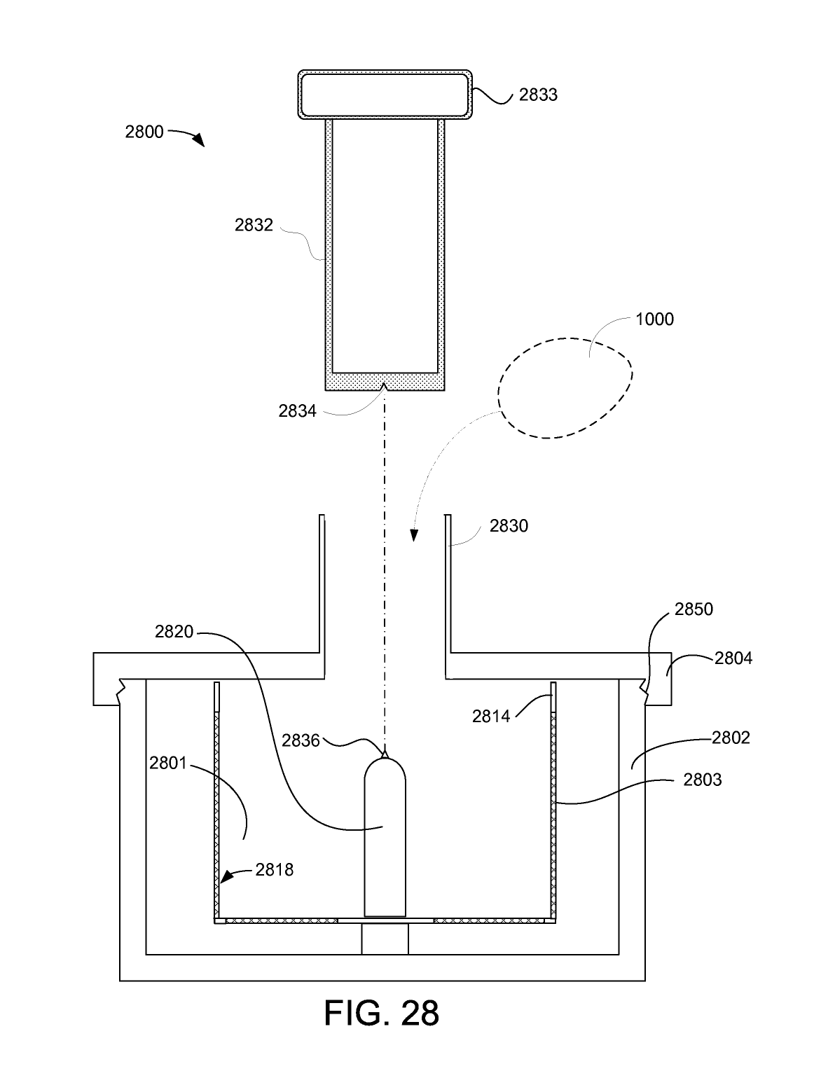

FIG. 28 is a side cross-sectional view illustrating another exemplary alternate embodiment 2800 of the exemplary embodiment 400 of FIG. 4, according to a preferred embodiment of the present invention. Egg spinner 2800 is similar to egg spinner 2300 except that the centrifuge basket 2801 has no basket lid 2322 and basket walls 2803 are higher than basket walls 2303. Container lid 2804 has a locking feature 2850 using an off-round lid to rotationally engage a cylindrical container wall 2802. Plunger 2832 has a handle 2833. Tube 2830 extends only above container lid 2804. Spike 2836 protrudes above axial pillar 2820 to assist in breaking eggs 1000 and receives conformal indentation 2834 in the bottom of plunger 2832. Operation is the same as for egg spinner 2300. The interior surface 2818 of foraminous wall 2803 is sufficiently non-abrasive to a poultry egg shell to resist powdering such egg shell 1102 during centrifuge operation.

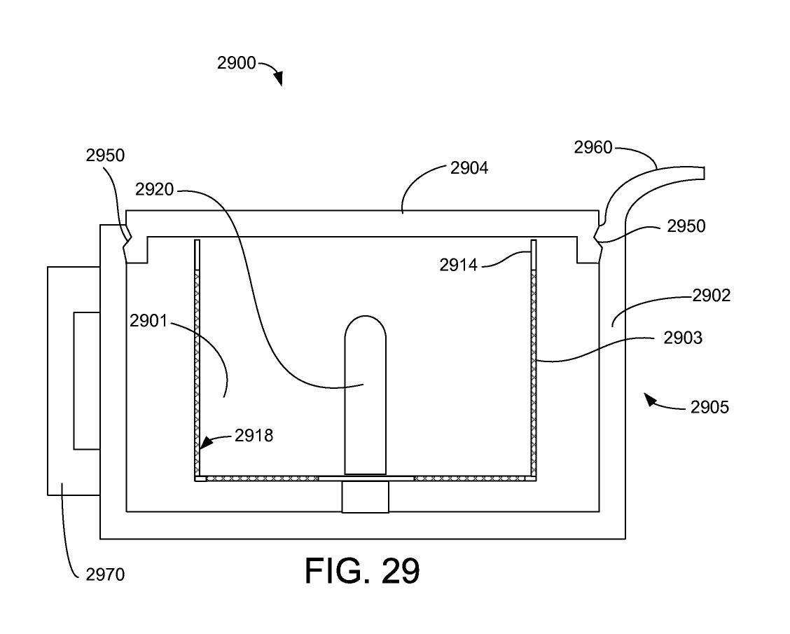

FIG. 29 is a side cross-sectional view illustrating another exemplary alternate embodiment 2900 of the exemplary embodiment 400 of FIG. 4, according to a preferred embodiment of the present invention. Egg spinner 2900 has a reclosable container 2905 with a pour spout 2960 hat is internally engaged by lid 2904 with locking features 2950 that work in concert with complimentary features on the inside of container wall 2902. Centrifuge basket 2901, axial pillar 2920, and basket wall 2903 are the same as for egg spinner 2800. The interior surface 2918 of foraminous wall 2903 is sufficiently non-abrasive to a poultry egg shell 1102 to resist powdering such egg shell during centrifuge operation. Exterior handle 2970 is preferably opposed to pour spout 2960 for ease of use.

In an exemplary egg spinner, the outside diameter of the centrifuge basket 2303 is 4.27 inches, the inside diameter of the centrifuge basket 2303 is 4.125 inches, and the inside depth of the centrifuge basket 2303 is 2.125 inches, with holes of a diameter of 0.055 inches in vertical rows having the holes vertically spaced 0.1 inches apart. Vertical columns of holes alternate as columns of 17 and columns of 18 holes each, with a 0.050 inch offset. Vertical columns of holes are spaced apart 3° of central angle. For such an embodiment, albumin may be separated from yolk of a pre-cracked egg at an angular velocity of 650 rpm. At 3000 rpm, whole eggs crack and transfer the yolk and albumin through the centrifuge wall and bottom and into the container. This embodiment retains the chalazae in the centrifuge basket, where it may be retrieved. Thus by cracking eggs into the centrifuge basket and retaining the shell by hand, the albumin may be separated at a first speed of 650 rpm and poured into a storage container, then the yolk may be separated from the chalazae at a second speed of 2500 rpm, leaving the chalazae to be retrieved from the centrifuge basket, and the yolk to be retrieved from the container.

The invention may be made with various centrifuge basket dimensions, hole sizes, and hole spacing, and the speeds corresponding to various egg separation operations may be found without undue experimentation by those of skill in the art who are enlightened by the present disclosure.

While the primary purpose of the egg spinner 400, 900, 1400, 2300, 2800, 2900 and other embodiments not illustrated is to spin eggs, the device is suitable for other tasks involving separating fluids and separating solids from fluids as well. Here are a few examples that are not intended to be exhaustive or limiting: dewatering (lettuce, canned tuna, fresh vegetables generally, etc.), degreasing (fried foods, canned tuna, etc.), removing seeds and such from soft or cooked fruit, making baby food from steamed vegetables, and removing nits from nut butters. Further, the various features of the different embodiments may be mixed and matched, within the limits of physical feasibility, to make additional embodiments that are not illustrated. The egg spinner may be embodied in ways that are not merely combinations of illustrated features, and such embodiments are within the scope of the present invention.

I claim:

1. An egg spinner for separating components of poultry eggs, said egg spinner having a plurality of user-selectable discrete rotational velocities for performing a corresponding plurality of egg separation operations, the egg spinner comprising:
a. a centrifuge basket comprising:
i. a foraminous cylindrical wall; and
ii. an interior surface of said wall, wherein said interior surface is sufficiently non-abrasive to a poultry egg shell to resist powdering such egg shell during centrifuge operation; and
b. wherein said centrifuge basket is operable to be controllably driven to at least one particular rotational velocity of said plurality of user-selectable discrete rotational velocities to cause at least one particular component of at least one poultry egg within said centrifuge basket to move through said foraminous cylindrical wall, while retaining at least one other particular component of such at least one poultry egg in said centrifuge basket.

2. The egg spinner of claim 1, further comprising a reclosable container operable to:
a. contain said centrifuge basket and to collect such at least one component of such at least one poultry egg after such at least one component moves through said foraminous cylindrical wall;
b. admit a torque drive element operable to rotationally drive said centrifuge basket; and
c. support said centrifuge basket within said container while said centrifuge basket is mechanically coupled to said torque drive element.

3. The egg spinner of claim 2, wherein said container further comprises at least one of:
a. a lid with a chute for inserting eggs into said centrifuge basket without removing said lid;
b. a lid with a chute for inserting at least one poultry egg into said centrifuge basket without removing said lid and a plunger for pushing such at least one poultry egg through said chute and onto a shell-breaking point of an axial pillar in said centrifuge basket; and
c. a lid with a chute for inserting at least one poultry egg into said centrifuge basket without removing said lid and a plunger for pushing such at least one poultry egg through said chute and onto a shell-breaking point of an axial pillar in said centrifuge basket, wherein said plunger has a cavity conformally shaped to receive said shell-breaking point.

4. The egg spinner of claim 2, wherein said container further comprises at least one of:
a. a lid operable to open and reclose said container;
b. a lid with a locking feature;
c. a lid adapted to enable manual rotation of said centrifuge basket;
d. a pour spout; and
e. an exterior handle.

5. The egg spinner of claim 2, further comprising:
a. a motor mechanically coupled to said torque drive element;
b. a motor controller linked to said motor and operable to control said rotational velocity of said motor; and
c. at least one manually operable input device linked to said motor controller and operable to enable manual selection of said at least one particular rotational velocity of said plurality of user-selectable discrete rotational velocities.

6. The egg spinner of claim 1, wherein said centrifuge basket comprises an axial pillar extending from a bottom of said centrifuge basket, wherein said axial pillar is operable to assist in manually breaking such at least one poultry egg upon entry of such at least one poultry egg into said centrifuge basket.

7. The egg spinner of claim 1, wherein said particular rotational velocity is a first rotational velocity of said plurality of user-selectable discrete rotational velocities operable to cause only egg albumin from such at least one broken poultry egg to move through said foraminous cylindrical wall.

8. The egg spinner of claim 1, wherein said particular rotational velocity is a second rotational velocity of said plurality of user-selectable discrete rotational velocities operable to cause only egg albumin and yolk from such at least one broken poultry egg to move through said foraminous cylindrical wall.

9. The egg spinner of claim 1, wherein said particular rotational velocity is a third rotational velocity of said plurality of user-selectable discrete rotational velocities operable to cause only egg albumin, yolk, and chalazae from such at least one broken poultry egg to move through said foraminous cylindrical wall.

10. The egg spinner of claim 1, wherein said particular rotational velocity is a fourth rotational velocity of said plurality of user-selectable discrete rotational velocities operable to first break such at least one poultry egg by centrifugal force and then cause only egg albumin and yolk from such at least one poultry egg to move through said foraminous cylindrical wall.

11. The egg spinner of claim 1, wherein said particular rotational velocity is a fifth rotational velocity of said plurality of user-selectable discrete rotational velocities operable to first break such at least one poultry egg by centrifugal force and then to cause only egg albumin, yolk, and chalazae from such at least one poultry egg to move through said foraminous cylindrical wall.

12. The egg spinner of claim 1, further comprising:
a. a motor mechanically coupled to said centrifuge basket;
b. a motor controller linked to said motor and operable to control said rotational velocity of said motor; and
c. at least one manually operable input device linked to said motor controller and operable to enable manual selection of said at least one particular rotational velocity of said plurality of user-selectable discrete rotational velocities.

13. The egg spinner of claim 1, wherein said foraminous cylindrical wall comprises:
a. a radially inner screen having perforations of a first size; and
b. a radially outer support wall for circumferentially abutting and supporting said radially inner screen and having perforations of a second size, wherein said second size is larger than said first size.

14. The egg spinner of claim 13, further comprising a plurality of interchangeable said radially inner screens, wherein each screen of said plurality of said radially inner screens has perforations of a unique first size.

15. The egg spinner of claim 1, wherein said centrifuge basket comprises a bottom, a top edge of said foraminous cylindrical wall, and at least one of:
a. an axial pillar extending from said bottom;
b. an axial pillar extending from said bottom and having a shell-fracturing point;
c. a plurality of perforations in said bottom;
d. a lid operable be releasably attached to said top edge of said foraminous cylindrical wall;
e. a lid operable be releasably attached and to said top edge of said foraminous cylindrical wall with a seal between said top edge and said lid;
f. a lid having an extension radially outward from said foraminous cylindrical wall; and
g. an un-perforated portion of said foraminous cylindrical wall proximate said top edge.

16. An egg spinner for separating components of poultry eggs, said egg spinner having a plurality of user-selectable discrete rotational velocities for performing a corresponding plurality of egg separation operations, said egg spinner comprising:
a. a centrifuge basket comprising:
i. a foraminous cylindrical wall; and
ii. an interior surface of said wall, wherein said interior surface is sufficiently non-abrasive to a poultry egg shell to resist powdering such egg shell during centrifuge operation; and
b. wherein said centrifuge basket is operable to be controllably driven to at least one particular rotational velocity of said plurality of user-selectable discrete rotational velocities for performing a corresponding particular egg separation operation of said plurality of egg separation operations to cause at least one particular component of at least one poultry egg within said centrifuge basket to move through said foraminous cylindrical wall, while retaining at least one other particular component of such at least one poultry egg;
c. wherein said centrifuge basket comprises a foraminous bottom and an axial pillar extending from said bottom, wherein said axial pillar is operable to assist in manually breaking such at least one poultry egg upon entry of such at least one poultry egg into said centrifuge basket.

17. The egg spinner of claim 16, further comprising a reclosable container:
a. that is operable to:
i. contain said centrifuge basket and to collect such at least one component of such at least one poultry egg when such at least one component moves through said foraminous cylindrical wall;
ii. admit a torque drive element operable to rotationally drive said centrifuge basket; and
iii. support said centrifuge basket within said container while said centrifuge basket is mechanically coupled to said torque drive element; and
b. further comprising at least one of:
i. a lid with a chute for inserting at least one poultry egg into said centrifuge basket without removing said lid;
ii. a lid with a chute for inserting at least one poultry egg into said centrifuge basket without removing said lid and a plunger for pushing such at least one poultry egg through said chute and onto a shell-breaking point of an axial pillar in said centrifuge basket;
iii. a lid with a chute for inserting at least one poultry egg into said centrifuge basket without removing said lid and a plunger for pushing such at least one poultry egg through said chute and onto a shell-breaking point of an axial pillar in said centrifuge basket, wherein said plunger has a cavity conformally shaped to receive said shell-breaking point;
iv. a lid operable to open and reclose said container;
v. a lid with a locking feature;
vi. a lid adapted to enable manual rotation of said centrifuge basket;
vii. a pour spout; and
viii. a shape adaptable to be used with a particular food processor.

18. The egg spinner of claim 17, further comprising:
a. a motor mechanically coupled to said torque drive element;
b. a motor controller linked to said motor and operable to control said rotational velocity of said motor; and
c. at least one manually operable input device linked to said motor controller and operable to enable manual selection of said at least one particular rotational velocity.

19. The egg spinner of claim 16, wherein said plurality of user-selectable discrete rotational velocities comprises at least two of:
a. a first rotational velocity of said plurality of user-selectable discrete rotational velocities operable to cause, when such at least one manually broken poultry egg is initially within said centrifuge basket, only egg albumin from such egg to move through said foraminous cylindrical wall;
b. a second rotational velocity of said plurality of user-selectable discrete rotational velocities operable to cause, when such at least one manually broken poultry egg is initially within said centrifuge basket, only egg albumin and yolk from such egg to move through said foraminous cylindrical wall;
c. a third rotational velocity of said plurality of user-selectable discrete rotational velocities operable to cause, when such at least one manually broken poultry egg is initially within said centrifuge basket, only egg albumin, yolk, and chalazae from such egg to move through said foraminous cylindrical wall;
d. a fourth rotational velocity of said plurality of user-selectable discrete rotational velocities operable, when such unbroken poultry egg is initially within said centrifuge basket, to first break such at least one poultry egg and then cause only egg albumin and yolk from such at least one poultry egg to move through said foraminous cylindrical wall; and
e. a fifth rotational velocity of said plurality of user-selectable discrete rotational velocities operable to first break such at least one poultry egg and then to cause only egg albumin, yolk, and chalazae from such at least one poultry egg to move through said foraminous cylindrical wall.

20. An egg spinner for separating components of poultry eggs, said egg spinner having a plurality of user-selectable discrete rotational velocities for performing a corresponding plurality of egg separation operations, the egg spinner comprising:
a. a centrifuge basket comprising:
i. a foraminous cylindrical wall;
ii. an interior surface of said wall, wherein said interior surface is sufficiently non-abrasive to a poultry egg shell to resist powdering such egg shell during centrifuge operation;
iii. a foraminous bottom closing said cylindrical wall;
iv. an axial pillar extending upward from said bottom, wherein said axial pillar is operable to assist in manually breaking such at least one poultry egg upon entry of such at least one poultry egg into said centrifuge basket;
v. a top edge of said foraminous cylindrical wall; and
vi. a non-perforated portion of said foraminous cylindrical wall proximate said top edge; and
b. wherein said centrifuge basket is controllable to operate at said plurality of user-selectable discrete rotational velocities for performing a corresponding plurality of egg separation operations, said velocities comprising:
i. a first rotational velocity of said plurality of user-selectable discrete rotational velocities operable to cause, when such at least one manually broken poultry egg is initially within said centrifuge basket, only egg albumin from such egg to move through said foraminous cylindrical wall;
ii. a second rotational velocity of said plurality of user-selectable discrete rotational velocities operable to cause, when such at least one manually broken poultry egg is initially within said centrifuge basket, only egg albumin and yolk from such egg to move through said foraminous cylindrical wall;
iii. a third rotational velocity of said plurality of user-selectable discrete rotational velocities operable to cause, when such at least one manually broken poultry egg is initially within said centrifuge basket, only egg albumin, yolk, and chalazae from such egg to move through said foraminous cylindrical wall;
iv. a fourth rotational velocity of said plurality of user-selectable discrete rotational velocities operable, when such unbroken poultry egg is initially within said centrifuge basket, to first break such at least one poultry egg and then cause only egg albumin and yolk from such at least one poultry egg to move through said foraminous cylindrical wall; and
v. a fifth rotational velocity of said plurality of user-selectable discrete rotational velocities operable, when such unbroken poultry egg is initially within said centrifuge basket, to first break such at least one poultry egg and then to cause only egg albumin, yolk, and chalazae from such at least one poultry egg to move through said foraminous cylindrical wall.
